(19) United States
(12) Patent Application Publication
(10) Pub. No.: US 2017/0308930 A1
(43) Pub. Date: Oct. 26, 2017

(54) VEHICLE ADVERTISING SYSTEM AND METHOD

(71) Applicant: Michael W. Shore, Dallas, TX (US)

(72) Inventor: Michael W. Shore, Dallas, TX (US)

(21) Appl. No.: 15/493,632

(22) Filed: Apr. 21, 2017

Related U.S. Application Data
(60) Provisional application No. 62/326,423, filed on Apr. 22, 2016.

(51) Int. Cl. G06Q 30/02

(52) U.S. Cl. CPC G06Q 30/0265

(57) ABSTRACT

A vehicle advertising system includes an electronic display located on a vehicle, the electronic display operably connected to a microcontroller. A vehicle brake pedal is operably connected to the microcontroller and the electronic display, wherein when an operator of the vehicle applies the brake pedal, one or more messages are displayed on the electronic display and when the operator releases the brake pedal, the message (or messages) is no longer displayed via the electronic display.

### CROSS-REFERENCE TO PROVISIONAL APPLICATION

This nonprovisional patent application claims the benefit under 35 U.S.C. §119(e) to U.S. Provisional Patent Application Ser. No. 62/326,423 filed on Apr. 22, 2016, entitled “Vehicle Advertising System and Method” and which is hereby incorporated by reference in its entirety.

### TECHNICAL FIELD

Embodiments are generally related to electronic displays utilized for advertising and the display of images and messages. Embodiments also relate to on-board vehicle electronics.

### BACKGROUND

Advertising media such as newspapers, public radio, television, and billboards has suffered a dramatic decrease in popularity and advertising effectiveness with the advent of the internet and mobile phone technology. Sponsors, therefore, are highly motivated to identify new methods of distributing advertisements in order to create effective brand awareness. As newer technologies such as mobile phones evolve into highly sophisticated two-way communication systems, such technologies can be leveraged to provide trackable advertising impressions and brand awareness by directly displaying advertisements and testimonials to potential customers.

### BRIEF SUMMARY

The following summary is provided to facilitate an understanding of some of the innovative features unique to the disclosed embodiments and is not intended to be a full description. A full appreciation of the various aspects of the embodiments disclosed herein can be gained by taking the entire specification, claims, drawings, and abstract as a whole.

It is, therefore, one aspect of the disclosed embodiments to provide for an improved electronic display.

It is another aspect of the disclosed embodiments to provide for an improved advertising system and method.

It is yet another aspect of the disclosed embodiments to provide for a vehicle advertising system.

The aforementioned aspects and other objectives and advantages can now be achieved as described herein. A vehicle advertising system includes an electronic display located on a vehicle, the electronic display operably connected to a microcontroller. A vehicle brake pedal is operably connected to the microcontroller and the electronic display, wherein when an operator of the vehicle applies the brake pedal, one or more messages are displayed on the electronic display and when the operator releases the brake pedal, the message (or messages) is no longer displayed via the electronic display.

In an example embodiment, the electronic display is located at the rear of the vehicle and message such as an advertisement can be displayed when the vehicle operator applies the brakes. The message disappears when the brakes are released, thereby also functioning in some embodiments as a braking indicator light or message with dual purposes. The messages can be programmable both by controls within the vehicle or alternatively can be downloaded to the vehicle remotely.

One example embodiment allows the vehicle owner to choose the ad he or she desires for display and to track when, where, and how many times the ad was displayed. This information can be used to provide compensation to the vehicle owner based upon the ad sponsor's preferences.

In another example embodiment, the system can track where the vehicle was located via a location system, the time of day when displays were made, the number of displays, and to the extent available the level of traffic. This data can be used in association with a particular formula to set the compensation for the display owner.

In still another example embodiment, different levels of control of ad content and use can be provided to third parties such as advertisers or ad aggregators. A GPS component can also track where the use of the ad was not legal or allowed by regulation or statute and turn it off automatically in such areas.

### BRIEF DESCRIPTION OF THE DRAWINGS

The accompanying figures, in which like reference numerals refer to identical or functionally-similar elements throughout the separate views and which are incorporated in and form a part of the specification, further illustrate the present invention and, together with the detailed description of the invention, serve to explain the principles of the present invention.

FIG. 1 illustrates a perspective view of a vehicle that can incorporate a vehicle advertising system, in accordance with an example embodiment;

FIG. 2 illustrates a vehicle advertising system, in accordance with an example embodiment;

FIG. 3 illustrates a vehicle advertising system, in accordance with another example embodiment;

FIG. 4 illustrates a vehicle advertising system with wireless communications capabilities, in accordance with another example embodiment;

FIG. 5 illustrates a flow chart of operations depicting logical operational steps of a method for vehicle advertising, in accordance with an example embodiment;

FIG. 6 illustrates a flow chart of operations depicting logical operational steps of a method for preparing a message for display via a vehicle-based electronic display, in accordance with an example embodiment;

FIG. 7 illustrates a server with a data mining module that communicates wirelessly with a wireless network and a database, in accordance with an example embodiment;

FIG. 8 illustrates a system for data-processing apparatus or system that can be utilized to implement instructions for a vehicle-based advertising system, in accordance with an example embodiment; and

FIG. 9 illustrates a schematic view of a software system including a module, an operating system, and a user interface, in accordance with an example embodiment.

### DETAILED DESCRIPTION

The particular values and configurations discussed in these non-limiting examples can be varied and are cited merely to illustrate at least one embodiment and are not intended to limit the scope thereof.

Subject matter will now be described more fully hereinafter with reference to the accompanying drawings, which form a part hereof, and which show, by way of illustration, specific example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware, or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood, at least in part, from usage in context. For example, terms such as “and,” “or,” or “and/or” as used herein may include a variety of meanings that may depend, at least in part, upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein, depending at least in part upon context, may be used to describe any feature, structure, or characteristic in a singular sense or may be used to describe combinations of features, structures, or characteristics in a plural sense. Similarly, terms such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

In the following detailed description, numerous specific details are set forth in order to provide a thorough understanding of some embodiments. However, it will be understood by persons of ordinary skill in the art that some embodiments may be practiced without these specific details. In other instances, well-known methods, procedures, components, units and/or circuits have not been described in detail so as not to obscure the discussion.

Discussions herein utilizing terms such as, for example, “processing,” “computing,” “calculating,” “determining,” “establishing,” “analyzing,” “checking,” or the like may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

The terms “plurality” and “a plurality,” as used herein, include, for example, “multiple” or “two or more.” For example, “a plurality of items” includes two or more items.

References to “one embodiment,” “an example embodiment,” “an embodiment,” “demonstrative embodiment,” “various embodiments,” etc., indicate that the embodiment(s) so described may include a particular feature, structure, or characteristic, but not every embodiment necessarily includes the particular feature, structure, or characteristic. Further, repeated use of the phrase “in one embodiment” does not necessarily refer to the same embodiment, although it may.

As used herein, unless otherwise specified, the use of the ordinal adjectives “first,” “second,” “third,” etc., to describe a common object, merely indicates that different instances of like objects are being referred to and are not intended to imply that the objects so described must be in a given sequence, either temporally, spatially, in ranking, or in any other manner.

Some embodiments may be used in conjunction with various devices and systems, for example, a Personal Computer (PC), a desktop computer, a mobile computer, a laptop computer, a notebook computer, a tablet computer, a Smartphone device, a smartwatch, a wearable computing devices, a server computer, a handheld computer, a handheld device, a Personal Digital Assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless Access Point (AP), a wired or wireless router, a wired or wireless modem, a video device, an audio device, an audio-video (A/V) device, a wired or wireless network, a cellular network, a cellular node, a Multiple Input Multiple Output (MIMO) transceiver or device, a Single Input Multiple Output (SIMO) transceiver or device, a Multiple Input Single Output (MISO) transceiver or device, a device having one or more internal antennas and/or extemal antennas, Digital Video Broadcast (DVB) devices or systems, multi-standard radio devices or systems, a wired or wireless handheld device, e.g., a Smartphone, a Wireless Application Protocol (WAP) device, vending machines, sell terminals, and the like.

Note that the term “server” as utilized herein refers generally to a computer that provides data to other computers. Such a server can serve data to systems on, for example, a LAN (Local Area Network) or a wide area network (WAN) over the Internet.

Many types of servers exist, including web servers, mail servers, and files servers. Each type can run software specific to the purpose of the server. For example, a Web server may run Apache HTTP Server or Microsoft IIS, which both provide access to websites over the Internet. A mail server may run a program such as, for example, Exim or iMail, which can provide SMPT services for sending and receiving email. A file server might utilize, for example, Samba or the operating system's built-in file sharing services to share files over a network. A server is thus a computer or device on a network that manages resources. Other examples of servers include print servers, database servers, and so on. A server may be dedicated, meaning that it performs no other tasks besides their server tasks. On multiprocessing operating systems, however, a single computer can execute several programs at once. A server in this case may refer to the program that is managing resources rather than the entire computer.

Some embodiments may be used in conjunction with devices and/or networks operating in accordance with existing Long Term Evolution (LTE) specifications, e.g., “3GPP TS 36.304 3rd Generation Partnership Project; Technical Specification Group Radio Access Network; Evolved Universal Terrestrial Radio Access (E-UTRA); User Equipment (UE) procedures in idle mode”; “3GPP TS 36.331 3rd Generation Partnership Project; Technical Specification Group Radio Access Network; Evolved Universal Terrestrial Radio Access (E-UTRA); Radio Resource Control (RRC); Protocol specification”; “3GPP 24.312 3rd Generation Partnership Project; Technical Specification Group Core Network and Terminals; Access Network Discovery and Selection Function (ANDSF) Management Object (MO)”; and/or future versions and/or derivatives thereof, units and/or devices which are part of the above networks, and the like.

Some embodiments may be used in conjunction with one or more types of wireless communication signals and/or systems, for example, Radio Frequency (RF), Frequency-Division Multiplexing (FDM), Orthogonal FDM (OFDM), Single Carrier Frequency Division Multiple Access (SC-FDMA), Time-Division Multiplexing (TDM), Time-Division Multiple Access (TDMA), Extended TDMA (E-TDMA), General Packet Radio Service (GPRS), extended GPRS, Code-Division Multiple Access (CDMA), Wideband CDMA (WCDMA), CDMA 2000, single-carrier CDMA, multi-carrier CDMA, Multi-Carrier Modulation (MDM), Discrete Multi-Tone (DMT), Bluetooth®, Global Positioning System (GPS), Wireless Fidelity (Wi-Fi), Wi-Max, ZigBee®, Ultra-Wideband (UWB), Global System for Mobile communication (GSM), second generation (2G), 2.5G, 3G, 3.5G, 4G, 5G, Long Term Evolution (LTE) cellular system, LTE advance cellular system, High-Speed Downlink Packet Access (HSDPA), High-Speed Uplink Packet Access (HSUPA), High-Speed Packet Access (HSPA), HSPA+, Single Carrier Radio Transmission Technology (1×RTT), Evolution-Data Optimized (EV-DO), Enhanced Data rates for GSM Evolution (EDGE), and the like. Other embodiments may be used in various other devices, systems, and/or networks.

The phrase “hand held device” and/or “wireless device” and/or “mobile device,” as used herein, includes, for example, a device capable of wireless communication, a communication device capable of wireless communication, a communication station capable of wireless communication, a portable or non-portable device capable of wireless communication, or the like. In some demonstrative embodiments, a wireless device may be or may include a peripheral that is integrated with a computer, or a peripheral that is attached to a computer. In some demonstrative embodiments, the phrase “hand held device” and/or “wireless device” and/or “mobile device” may optionally include a wireless service and may also refer to wearable computing devices such as smartwatches and eyeglass computing devices (e.g., Google Glass, etc.).

The term “communicating” as used herein with respect to a wireless communication signal includes transmitting the wireless communication signal and/or receiving the wireless communication signal. For example, a wireless communication unit, which is capable of communicating a wireless communication signal, may include a wireless transmitter to transmit the wireless communication signal to at least one other wireless communication unit, and/or a wireless communication receiver to receive the wireless communication signal from at least one other wireless communication unit.

Some demonstrative embodiments are described herein with respect to a LTE cellular system. However, other embodiments may be implemented in any other suitable cellular network, e.g., a 3G cellular network, a 4G cellular network, a 5G cellular network, a WiMax cellular network, and the like. For example, in some embodiments the wireless network 44 shown in FIG. 4 may function as such cellular network(s) and/or other types of wireless networks discussed above.

The terms “cell” or “cellular” as used herein, may include a combination of network resources, for example, downlink and optionally uplink resources. The resources may be controlled and/or allocated, for example, by a cellular node (also referred to as a “base station”) or the like. The linking between a carrier frequency of the downlink resources and a carrier frequency of the uplink resources may be indicated, for example, in system information transmitted on the downlink resources.

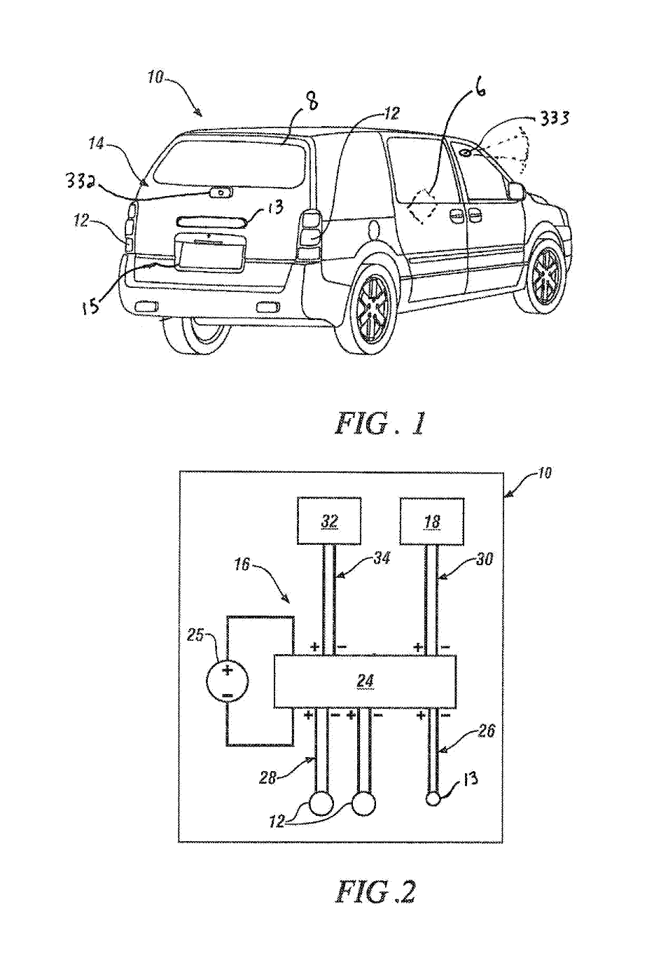

FIG. 1 is a perspective view of a vehicle 10 that can incorporate a vehicle advertising system, in accordance with an example embodiment. One or more of the disclosed embodiments relates to a method and system (referred to collectively as “BrakeAd”) in which a display 13 is located on the rear of a vehicle 10 where an advertisement (“ad” or “Ad”) or message is displayed when the operator of the vehicle 10 applies the brakes. The message disappears when the brakes are released, so it acts as a braking indicator light or message with dual purposes. The messages are programmable both by controls within the vehicle 10 (e.g., controls provided by an on-board computer) or alternatively can be downloaded to the vehicle 10 remotely (e.g., through wireless communications, as described in greater detail herein) to, for example, an on-board computer or a mobile device that communicates with such an on-board computer.

One example embodiment allows the owner/operator of the vehicle 10 to choose the ad he or she wants to display and track when, where, and how many times the ad was displayed. This information can be utilized to provide compensation to the vehicle owner based upon the ad sponsor's preferences. For example, Coca-Cola may want to have people display “Drink Coke” when they apply their brakes, but would be willing to pay more on busy freeways during high traffic periods. Such an example system can track where the vehicle 10 was located via a location system, the time of day when displays were made, the number of displays, and to the extent available the level of traffic. This data can be utilized in conjunction with some formula to set the compensation for the display owner. Other example embodiments can provide for levels of control of Ad content and use to third parties like advertisers or Ad aggregators. A GPS component can be employed to track where the use of the ad was not legal or allowed by regulation or statute and turn it off automatically in such areas. Example embodiments may be all remote to each vehicle, centrally managed, or some combination thereof.

Referring to FIG. 1, in accordance with an exemplary embodiment of the invention, the vehicle is shown in the form of an automobile and is generally referred to with numeral 10. Although the vehicle 10 is illustrated as an automobile, it is to be appreciated that the embodiments disclosed herein may be employed in combination with various alternative types of vehicles. With respect to an automobile, it is to be further appreciated that the specific type of automobile is irrelevant to carrying out the embodiments described below. For example, the automobile may include a car, truck, sport utility vehicle (SUV), or van. The preceding list is merely illustrative and is not intended to be limiting of the numerous automobile types that may benefit from the embodiments.

The vehicle 10 includes an electronic display 13 and at least one brake light 12, but typically a plurality of brake lights will be employed. The electronic display 13 and the at least one brake light 12 are disposed proximate a rearward region 14 of the vehicle 10 and may be located at various heights along the rearward region 14. The at least one brake light 12 and/or the electronic display 13 can be configured to switch between an illuminated state and a non-illuminated state. The illuminated state of the at least one brake light 12 and/or the electronic display 13 can be achieved by routing of electricity to the at least one brake light 12 and/or the electronic display 13, which may each comprise a light bulb and/or a light emitting diode (LED). In the illuminated state, the at least one brake light 12 and/or electronic display 13 may be displayed as various colors, however, a relatively red or amber color, or the like is typically displayed to alert drivers of surrounding vehicles in close proximity to the vehicle 10, particularly a driver of a following vehicle travelling directly behind the vehicle 10, that braking of the vehicle 10 is occurring. Such an alert prompts the following vehicle to take appropriate measures, such as slowing down to accommodate for the braking of the vehicle 10.

Note that although the electronic display is shown in FIG. 1 as being located above the license plate area at the rear of the vehicle 10, it can be appreciated that the electronic display may be located elsewhere on the vehicle or may be composed of not a single display, but several display areas wherein messages are electronically display. In some example embodiments, the electronic display may be incorporated into or with, for example, a window area such as the rear window 8. In some example embodiments, the electronic display may be implemented in the context of particular display devices, such as, for example, an electronic holographic display that utilizes light diffraction to create a virtual three-dimensional image of an object. Such a holographic display or another form of 3D imaging can be utilized to electronically display images in electronic display 13 without requiring the aid of any special glasses or external equipment for a viewer (e.g., other drivers and/or passengers in other vehicles) to see the messages including images displayed via the electronic display 13.

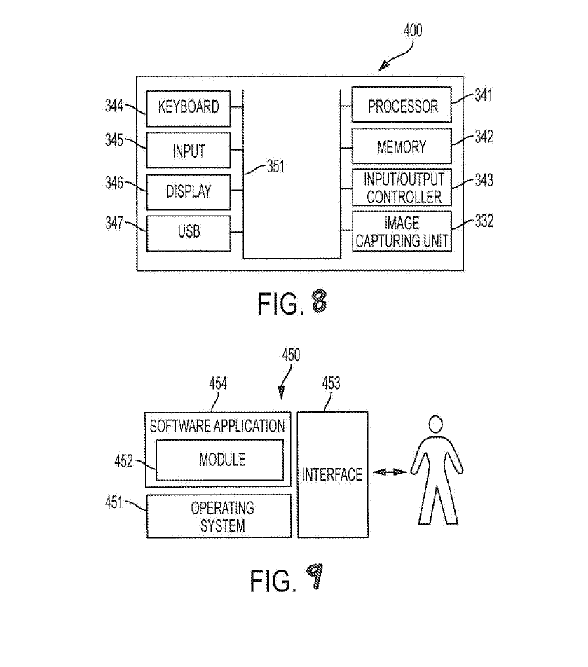

In some example embodiments, the vehicle 10 may be equipped with an image-capturing unit 332 (e.g., a digital video camera) that can be utilized to capture impressions of drivers and passengers located in other vehicles nearby and/or by pedestrians who are happened to catch a glimpse of the message displayed via the electronic display 13 as the vehicle 10 passes them. Note that such an image-capturing unit 332 is also discussed herein with respect to the data-processing system shown in FIG. 8. It can be appreciated that the image-capturing unit can be located anywhere on the vehicle 10 although placement at the rear of the vehicle may be optimal for obtaining impressions of other drivers/passengers in other cars located to the rear of the vehicle 10.

FIG. 2 illustrates a vehicle advertising system 16, in accordance with an example embodiment. Referring now to FIG. 2, the vehicle advertising system 16 may be disposed at various locations within the vehicle 10 and can include the previously described at least one brake light 12. System 16 generally functions to alert the driver of a following vehicle of an unsafe following distance, with respect to the rearward region 14 of the vehicle 10. The system 16 provides such an alert without requiring actual braking of the vehicle 10, thereby alleviating the need for a user of the vehicle 10 to physically depress a brake pedal 18 that is disposed proximate the user's foot at an interior region of the vehicle 10.

System 16 includes the previously discussed electronic display 13, which communicates electronically with a controller 24 that is also electronically connected to the brake pedal 18 and an optional switch 32 (e.g., a toggle switch or other switching component). The electronic display 13 can be disposed proximate the rearward region 14 of the vehicle 10 as shown in the example embodiment of FIG. 1. In some example embodiments, the electronic display 13 may be located along an exterior surface of the rearward region 14 of the vehicle 10, or in a recess therein or at other locations on the vehicle 10. As is the case with the at least one brake light 12, electronic display 13 may be located at various heights along the rearward region 14.

The electronic display 13 is in operable communication with the controller 24, such as an electronic control unit (ECU), which can be configured for receiving a variety of information and can also be configured to perform numerous functions associated with operation of various electrical systems and/or subsystems in the vehicle 10. The controller 24 is provided power by a power source 25, such as a battery, which may be in the form of a 12V direct current (DC) battery. The operable communication between the electronic display 13 and the controller 24 facilitates relaying of a message or other data (e.g., multimedia data) for display via the electronic display 13. A signal can be sent from controller 24 to, for example, the at least one brake light 12 which initiates the illuminated state of at least one brake light. Similarly, a signal 26 can be sent from the controller 24 to the electronic display 13 to initiate the display of a message or other data via the electronic display 13.

The brake pedal 18 is also in operable communication with the controller 24 and in combination with applying the brakes of the vehicle 10 to slow down the vehicle 10, depression of the brake pedal 18 additionally sends an override signal 30 to the controller 24 that overrides the ability of the controller 24 to send the alert signal 28 to the at least one brake light 12. The override signal 30 ensures that a steady illumination of the at least one brake light 12 is provided during actual braking of the vehicle 10. The brake light system 16 may be completely overridden and disabled by the user of the vehicle 10 by manually switching a toggle switch 32 to an “off” position. Conversely, to enable the brake light system 16, the toggle switch 32 may be manually adjusted to an “on” position. The toggle switch 32 is in operable communication with the controller 24, with the operable communication facilitating the provision of an enable/disable signal 34 to the controller 24.

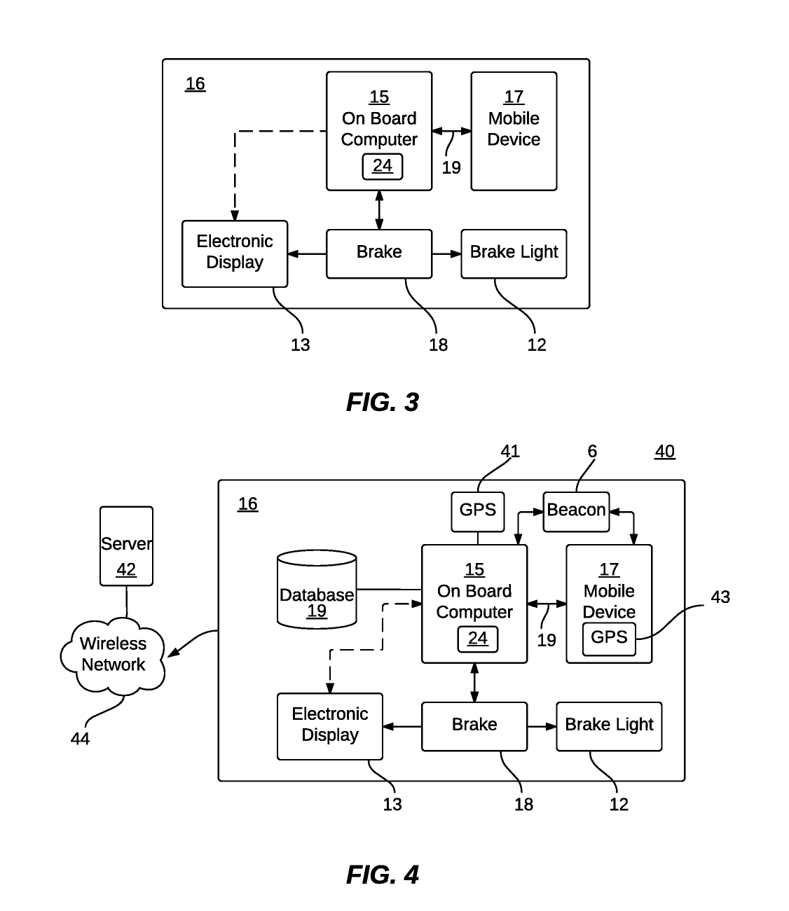

FIG. 3 illustrates the vehicle advertising system 16, in accordance with another example embodiment. The vehicle advertising system 16 can include the electronic display 13, the brake pedal 18, and the at least one brake light 12 as discussed previously. An on-board computer 15 can be connected electronically with the brake pedal 18. The on-board computer 15 can include the controller 24 illustrated in FIG. 2. System 16 can be implemented with vehicle 10 and also in association or with the configuration shown in FIG. 2. The brake pedal 18 is thus electrically and operably connected to the onboard computer 15 and also to the brake light 12 and the electronic display 13.

A message or ad can be displayed via the display 13 when the vehicle operator applies the brake pedal 18. The message disappears when the brake pedal 18 is released and can therefore act as a braking indicator light or message with dual purposes. Such messages can be programmable both by controls within the vehicle 10 provided by the on-board computer 15 and/or can be downloaded to the vehicle 10 remotely (e.g., through wireless communications, as described in greater detail herein) to, for example, the on-board computer 15 or to a mobile device 17 (e.g., smartphone, tablet computing device, smartwatch, etc.) that communicates with the on-board computer 15 via wireless communications 19 (e.g., wireless communication protocols, a wireless network, etc.).

Note that the wireless communications 19 between the mobile device 17 and the on-board computer 15 can occur through a wireless network such as an in-car PAN (Personal Area Network) including Bluetooth communications or other communications means such as, for example, a cellular network.

In one example embodiment, for example, the wireless communications 19 may implement an in-vehicle Bluetooth wireless communications system. In this scenario, it is assumed that on-board computer 15 is configured as, for example, a Bluetooth enabled computing device and the mobile device 17 (e.g., smartphone or tablet computing device) is also a Bluetooth enabled computing device.

The wireless communications 19 may also be implemented as a PAN (Bluetooth or otherwise). It should be appreciated that wireless communications 19 may be implemented not just via Bluetooth communications, but also through one of a number of possible alternative PAN wireless technologies. For example, in one embodiment wireless communications 19 may be implemented as a PAN based on induction wireless technology, which uses magnetic induction rather than radio for close-range communications. In radio, both electric and magnetic fields make up the signal, while in induction wireless, only the magnetic field is transmitted. The transmitter in this context is a radiating coil that is more like the primary winding of a transformer than an antenna. A PAN based on an induction wireless approach has about a 3-m range. A typical unit transmits up to 204.8-kbit/s data rates via GMSK modulation on 11.5 MHz. Key benefits of induction wireless technologies are extremely low power consumption, low cost, and the inherent security that accompanies short range.

Another implementation of wireless communications 19 can involve the use of infrared wireless communications. Such a PAN technology can be employed for use over short distances. The IrDA infrared (IR) standard appeared during the early 1990s and can be utilized to implement wireless communications 19 as a PAN network. IrDA initially offered a 115.2-kbit/s data rate over a range of up to 1 m. A 4-Mbit/s version was soon developed and has been widely incorporated in laptops and PDAs for printer connections and short-range PANs. A 16-Mbit/s version is available too.

The problem with IrDA is not just its very short range, but also its need for a line-of-sight (LOS) connection. Of course, Bluetooth does not need LOS and it can blast through walls. A more recent IR development is IrGate, which was produced by Infra-Com Technologies. This new IR development uses arrays of high-powered IR LEDs to emit coded baseband IR in all directions. Then, it relies on an array of photodetectors and super-sensitive receivers to pick up the diffused IR within the networking space. Thus, the LOS problem is mitigated and a data rate of up to 10 Mbits/s is possible.

Still another wireless technology for implementing wireless communications 19 in the context of, for example, an in-vehicle PAN is UWB (Ultra-Wideband), which transmits data by way of baseband pulses applied directly to the antenna. The narrow pulses (less than 1 ns) create an extremely broad bandwidth signal. The pulses are modulated by pulse position modulation (PPM) or binary phase-shift keying (BPSK). The FCC permits UWB in the 3.1- to 10.6-GHz band. Its primary application to date has been short-range, high-resolution radar, and imaging systems that penetrate walls, the ground, and the body. In addition, this new technology is useful for short-range LANs or PANs that require very high data rates (over 100 Mbits/s).

Still another wireless technology for implementing wireless communications 19 in the context of, for example, an in-vehicle PAN is ZigBee, which is a simpler, slower lower-power, lower-cost cousin of Bluetooth. ZigBee is supported by a mix of companies that are targeting the consumer and industrial markets. It may be a better fit with games, consumer electronic equipment, and home-automation applications than Bluetooth. Short-range industrial telemetry and remote control are other target applications. It can be appreciated, however, that wireless communications 19 can be implemented as a ZigBeen PAN.

Previously referred to as RF-Lite, ZigBee is similar to Bluetooth because it uses the 2.4-GHz band with frequency-hopping spread-spectrum with 25 hops spaced every 4 MHz. The basic data rate is 250 kbits/s, but a slower 28-kbit rate is useful for extended range and greater reliability. With a 20-dBm power level, ZigBee can achieve a range of up to 134 meters at 28 kbits/s. It additionally allows for networking of up to 254 nodes.

FIG. 4 illustrates vehicle advertising system 40, in accordance with another example embodiment. Note that in FIGS. 2-3, identical or similar parts are generally indicated by identical reference numerals. System 40 shown in FIG. 4 generally includes the system 16 depicted in FIG. 2. As shown in FIG. 4, system 16 can communicate wirelessly with a wireless network 44 that is operably connected to a server 42. Wireless network 44 is preferably implemented as a cellular network accessible by the mobile device 17 and/or the on-board computer 15. In the example shown in FIG. 4, the on-board computer can be configured with instructions for monitoring the type of messages displayed on the electronic display 13, the duration of display, and other types of data indicative of the display of messages (e.g., advertisements) and save this information in a database 19, which can be later retrieved and mined for information and data concerning the messages by the server 42 in communication with the wireless network 44. In addition, impressions captured by the image-capturing unit 332 can be stored in database 19 (or elsewhere such as in a database or memory associated with server 42) for later data mining.

In this manner, the owner/operator of the vehicle 10 (or another authorized person or entity) selects the message (e.g., ad) that he or she wants to display and track when, where, and how many times the ad was displayed. This information is stored in database 19 and can also be utilized to provide compensation to the vehicle owner based upon the ad sponsor's preferences. For example, as indicated previously Coca-Cola may want to have people display “Drink Coke” when they apply their brakes, but would be willing to pay more on busy freeways during high traffic periods. Such an example system can track where the vehicle 10 was located via a location system, the time of day when displays were made, the number of displays via electronic display 13, and to the extent available the level of traffic. This data contained in database 19 can be utilized in conjunction with some formula to set the compensation for the display owner.

Other example embodiments can provide for levels of control of ad content and use to third parties, like advertisers or ad aggregators. For example, a GPS component such as GPS module 41 and/or a GPS module 43 can be employed to track where the use of the ad was not legal or allowed by regulation or statute and turn it off automatically in such areas. In the example shown in FIG. 4, the GPS module 41 can be operably connected to the on-board computer 15. The GPS module 43 is integrated with the mobile device 17. Note that the term GPS module as utilized herein can refer to a device (including hardware and software) that uses the Global Positioning System to ascertain the geographical location of vehicle 10 and also to record the location of vehicle 10 at periodic or other intervals.

Note that system 16 may be operated with or without the mobile device 17, which is optional but also useful in a variety of situations. For example, a user may download an “app” from an online store, which is saved on the mobile device 17 and then when activated via the mobile device 17, allows the user (e.g., the owner of the vehicle 10) to type in a particular message (e.g., “Drink Coke”) or download a particular message from the Internet via the map. For example, an advertiser may provide an app with a number of advertising messages that a user can select from for display via the electronic display 13. A similar app may be available via the on-board computer 15.

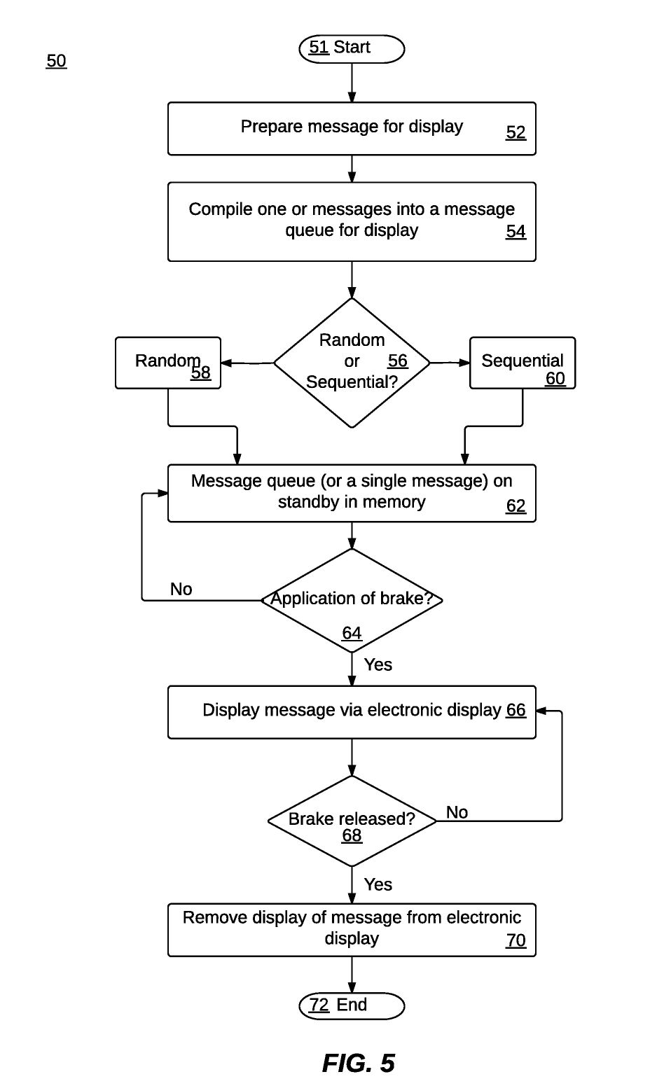

FIG. 5 illustrates a flow chart of operations depicting logical operational steps of a method 50 for vehicle advertising, in accordance with an example embodiment. As indicated at block 51, the process is initiated. Then, as illustrated at block 52, a message (e.g., an advertisement, image or images, text, video etc.) can be prepared for display. In this step, the message may be input by, for example, a vehicle owner or a third party such as an advertising agency or a sponsor.

Then, as illustrated at block 54, the message (or messages) can be compiled into a message queue, which orders how the messages are to be displayed by the electronic display 13. The message queue can be set as random or sequential, as indicated at decision block 56 and at blocks 58 (“random”) and 60 (“sequential”). In other words, the queue may display messages in a particular sequential order or randomly. Thereafter, as depicted at block 62, the message queue (or a single message) is put into a standby mode in a memory (e.g., computer memory) for retrieval and display.

As depicted next at block 64, a test can be performed to determine if the brake pedal 18 has been pressed. If so, then as indicated at block 66, the messages in the message queue are displayed via the electronic display 13 in a sequential or random order while the brake is pressed. In the case of a single message (rather than multiple messages in a message queue), just one message is displayed via the electronic display 13, in which case it may not be necessary to designate a sequential or random display of the message (since there would only be one message). If the brake pedal has not been pressed, then the message queue remains in a standby mode. Following processing of the operation depicted at block 66, a test can be performed as indicated at decision block 68 to determine if the brake pedal is released. If so, then the message or messages are no longer displayed via the electronic display 13, as depicted at block 70. The process then ends, as indicated at block 72.

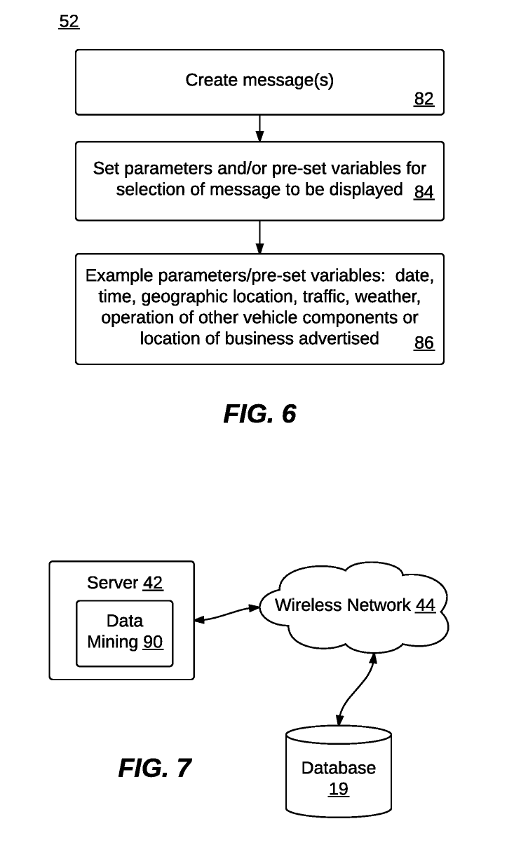

FIG. 6 illustrates a flow chart of operations depicting logical operational steps of a method 52 for preparing a message for display via a vehicle-based electronic display, in accordance with an example embodiment. The method 52 shown in FIG. 6 includes logical operations for implementing the operation shown at block 52 in FIG. 5 (i.e., preparing a message or messages for display). As shown at block 82 in FIG. 6, a message (or multiple messages) can be created. Such a message(s) may be created by, for example, the owner of the vehicle or a third party such as an advertiser or sponsor. As shown next at blocks 84 and 86, parameters and/or pre-set variables for selection of the message to be displayed can be set. That is, ad/message selection can be based on parameters set by the advertiser or driver utilizing preset variables such as date, time, geographic location, traffic, weather, operation of other vehicle components (e.g., wipers, headlights, etc.), or the location of a business advertised (e.g. Next Exit “DQ” or “DairyQueen”).

FIG. 7 illustrates server 42 depicted in FIG. 4 with a data mining module 90 that communicates wirelessly with the wireless network 44 and the database 19, in accordance with an example embodiment. The data mining module 90 is stored in a memory location in the server 42 and includes data mining instructions, which are then processed by a processor at the server 42 and/or located elsewhere. For example, the on-board computer 15 also contains a processor that can process some or all of these data mining instructions and/or in association with data mining instructions maintained by module 90 at the server 42.

Note that the term data mining as utilized herein refers to an interdisciplinary subfield of computer science and is a computation process of discovering patterns in large data sets involving methods at the intersection of artificial intelligence, machine learning, statistics and database systems. An overall goal of the data mining process is to extract information from a data set and transform it into an understandable structure for further use. Aside from the raw analysis step, data mining can involve database and data management aspects, data pre-processing, model and inference considerations, interestingness metrics, complexity considerations, post-processing of discovered structures, visualization and online updating. In some example embodiments, data mining can involve the analysis step of the “knowledge discovery in databases” process, or KDD.

The term data mining as utilized herein can involve the extraction of patterns and knowledge from large amounts of data, not necessarily the extraction (mining) of data itself. Data Mining can also involve large-scale data or information processing (e.g., collection, extraction, warehousing, analysis, and statistics) as well as any application of computer decision support system, including artificial intelligence, machine learning, and business intelligence business.

Data mining tasks can involve the automatic or semi-automatic analysis of large quantities of data to extract previously unknown, interesting patterns such as groups of data records (e.g., cluster analysis), unusual records (e.g., anomaly detection), and dependencies (e.g., association rule mining). This usually involves using database techniques such as spatial indices. These patterns can then be seen as a kind of summary of the input data and may be used in further analysis or, for example, in machine learning and predictive analysis. For example, the data mining step might identify multiple groups in the data, which can then be used to obtain more accurate prediction results by a decision support system. Neither the data collection, data preparation, nor result interpretation and reporting is part of the data mining step, but can belong to the overall KDD process as additional steps.

Note that in some embodiments, computer program code for carrying out operations of the disclosed embodiments may be written in an object oriented programming language (e.g., Java, C#, C++, etc.). Such computer program code, however, for carrying out operations of particular embodiments can also be written in conventional procedural programming languages, such as the “C” programming language or in a visually oriented programming environment, such as, for example, Visual Basic.

The program code may execute entirely on the user's computer, partly on the user's computer, as a stand-alone software package, partly on the user's computer and partly on a remote computer, or entirely on the remote computer. In the latter scenario, the remote computer may be connected to a user's computer through a local area network (LAN) or a wide area network (WAN), wireless data network e.g., Wi-Fi, Wimax, IEEE 802.xx, and cellular network, or the connection may be made to an external computer via most third party supported networks (e.g., through the Internet via an Internet Service Provider).

The embodiments are described at least in part herein with reference to flowchart illustrations and/or block diagrams of methods, systems, and computer program products and data structures according to embodiments of the invention. It will be understood that each block of the illustrations, and combinations of blocks, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the various block or blocks, flowcharts, and other architecture illustrated and described herein.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the block or blocks.

FIGS. 8-9 are provided as exemplary diagrams of data-processing environments in which embodiments may be implemented. It should be appreciated that FIGS. 8-9 are only exemplary and are not intended to assert or imply any limitation with regard to the environments in which aspects or embodiments of the disclosed embodiments may be implemented. Many modifications to the depicted environments may be made without departing from the spirit and scope of the disclosed embodiments.

As illustrated in FIG. 8, some embodiments may be implemented in the context of a data-processing system 400 that can include one or more processors such as processor 341, a memory 342, a controller 343 (e.g., an input/output controller), a peripheral USB (Universal Serial Bus) connection 347, a keyboard 344 (e.g., a physical keyboard or a touch screen graphically displayed keyboard), an input component 345 (e.g., a pointing device, such as a mouse, track ball, pen device, which may be utilized in association or with the keyboard 344, etc.), a display 346, and in some cases, an image-capturing unit 332 (e.g., a digital video camera). Data-processing system 400 may be, for example, a client computing device (e.g., a client PC, laptop, tablet computing device, etc.), which communicates with peripheral devices (not shown) via a client-server network (e.g., wireless and/or wired). In another embodiment, the data-processing system may be a server in the context of a client-server network or other server-based network implementation such as, for example, the server 42 and wireless network 44 shown in FIG. 4.

As illustrated, the various components of data-processing system 400 can communicate electronically through a system bus 351 or other similar architecture. The system bus 351 may be, for example, a subsystem that transfers data between, for example, computer components within data-processing system 400 or to and from other data-processing devices, components, computers, etc. Data-processing system 400 may be implemented as, for example, a server in a client-server based network (e.g., the Internet) or can be implemented in the context of a client and a server (i.e., where aspects are practiced on the client and the server). Data-processing system 400 may be, for example, a standalone desktop computer, a laptop computer, a Smartphone, a pad computing device, a server, and so on. In some example embodiments, data-processing system 400 may be implemented as, for example, the on-board computer 15 and/or, for example, a mobile device such as the mobile device 17.

FIG. 9 illustrates a computer software system 450 for directing the operation of the data-processing system 400 shown in FIG. 8. Software application 454 stored, for example, in memory 342, generally includes a kernel or operating system 451 and a shell or interface 453. One or more application programs, such as software application 454, may be “loaded” (i.e., transferred from, for example, memory 342 or another memory location) for execution by the data-processing system 400. The data-processing system 400 can receive user commands and data through the interface 453; these inputs may then be acted upon by the data-processing system 400 in accordance with instructions from operating system 451 and/or software application 454. The interface 453, in some embodiments, can serve to display results, whereupon a user may supply additional inputs or terminate a session.

The software application 454 can include one or more modules such as, for example, a module 452 (or a module composed of a group of modules), which can, for example, implement instructions or operations such as those described herein. Examples of instructions that can be implemented by module 452 include steps or operations such as those shown and described herein.

The following discussion is intended to provide a brief, general description of suitable computing environments in which the system and method may be implemented. Although not required, the disclosed embodiments will be described in the general context of computer-executable instructions, such as program modules, being executed by a single computer. In most instances, a “module” such as module 452 shown in FIG. 9 constitutes a software application. However, a module may also be composed of, for example, electronic and/or computer hardware or such hardware in combination with software. In some cases, a “module” can also constitute a database and/or electronic hardware and software that interact with such a database. Module 452 can implement, for example, the data mining module 90 shown in FIG. 7 and/or instructions such as those show in FIGS. 5-6.

Generally, program modules include, but are not limited to, routines, subroutines, software applications, programs, objects, components, data structures, etc., that perform particular tasks or implement particular abstract data types and instructions. Moreover, those skilled in the art will appreciate that the disclosed method and system may be practiced with other computer system configurations, such as, for example, hand-held devices, multi-processor systems, data networks, microprocessor-based or programmable consumer electronics, networked PCs, minicomputers, mainframe computers, servers, and the like.

Note that the term module as utilized herein can refer to a collection of routines and data structures that perform a particular task or implement a particular abstract data type. Modules may be composed of two parts: an interface, which lists the constants, data types, variable, and routines that can be accessed by other modules or routines; and an implementation, which is typically private (accessible only to that module) and which includes source code that actually implements the routines in the module. The term module may also simply refer to an application, such as a computer program designed to assist in the performance of a specific task, such as word processing, accounting, inventory management, etc. Thus, the instructions or steps such as those shown in FIGS. 5-6, for example, and discussed elsewhere herein can be implemented in the context of such a module or modules, sub-modules, and so on.

FIGS. 8-9 are intended as examples and not as architectural limitations of disclosed embodiments. Additionally, such embodiments are not limited to any particular application or computing or data processing environment. Instead, those skilled in the art will appreciate that the disclosed approach may be advantageously applied to a variety of systems and application software. Moreover, the disclosed embodiments can be embodied on a variety of different computing platforms, including, for example, Windows, Macintosh, UNIX, LINUX, and the like.

The disclosed system can automatically send a message to a server (e.g., data processing system 400) when the advertising is displayed to count the advertising and ensure payment is made by applying a particular payment formula. This can be combined with a GPS system wherein what an advertising driver is paid is based upon his or her location, the density of traffic at the time, the identity of the driver behind them, the type of car behind them, etc. Thus, if a driver is in a rich area of town, a particular demographic area, a college area, etc., the location of the car can dictate what ad is displayed to target the type of people in that area. What ad is displayed and what the advertiser is paid can be based on a formula and tied to GPS or another system (e.g., OnStar) that tracks the vehicle's location, etc. For example, in the example where if a car is stolen, meaning started any way other than by inserting the key or using the correct key fob, the message can be displayed as, for example, “THIS CAR IS STOLEN. PLEASE CONTACT POLICE”.

Based on the foregoing, it can be appreciated that a number of example embodiments are disclosed herein. For example, in one example embodiment, a vehicle advertising system is disclosed, which includes an electronic display located on a vehicle, the electronic display operably connected to a microcontroller; and a brake pedal operably connected to the microcontroller and the electronic display, wherein when an operator of the vehicle applies the brake pedal, at least one message is displayed on the electronic display and when the operator releases the brake pedal, the at least one message is no longer displayed via the electronic display.

In some example embodiments, the at least one message is programmable via an on-board computer integrated with the vehicle, wherein the on-board computer includes the microcontroller and is operably connected to the electronic display. In another example embodiment, the at least one message is programmable via a mobile device that communicates wirelessly with the on-board computer. In another example embodiment, the at least one message is downloadable to the on-board computer. In yet another example embodiment, the at least one message is selectable from among a plurality of messages for display via the electronic display. In still another example embodiment, the at least one message is provided by an advertiser and comprises an advertisement displayable via the electronic display.

In an another example embodiment, a GPS component can be utilized, wherein a location when the at least one message is displayed by the electronic display is recorded and tracked. In still another example embodiment, a selection of the at least one message can be based on parameters preset by a third party advertiser. In another example embodiment, a selection of the at least one message for display via the electronic display can be based on preset variables designated by a driver or an owner of the vehicle.

In another example embodiment, a selection of the at least one message for display via the electronic display can be based on preset variables designated by a driver or an owner of the vehicle. In yet another example embodiment, a selection of the at least one message for display via the electronic display can be based on preset variables including at least one vehicle component associated with the vehicle and/or a location of the at least one vehicle and/or a location of a particular business.

In yet another example embodiment, an image-capturing unit can be used for capturing impressions with respect to a display of the at least one message displayed via the electronic display. In some example embodiment, the electronic display can comprise a holographic display. In another example embodiment, a beacon can be provided that wirelessly communicates with at least one mobile device and/or at least one on-board computer in another vehicle.

It will be appreciated that variations of the above-disclosed and other features and functions, or alternatives thereof, may be desirably combined into many other different systems or applications. It will also be appreciated that various presently unforeseen or unanticipated alternatives, modifications, variations or improvements therein may be subsequently made by those skilled in the art, which are also intended to be encompassed by the following claims.

What is claimed is:

1. A vehicle advertising system, comprising:
an electronic display located on a vehicle, said electronic display operably connected to a microcontroller; and
a brake pedal operably connected to said microcontroller and said electronic display, wherein when an operator of said vehicle applies said brake pedal, at least one message is displayed on said electronic display and when said operator releases said brake pedal, said at least one message is no longer displayed via said electronic display.

2. The vehicle advertising system of claim 1 wherein said at least one message is programmable via an on-board computer integrated with said vehicle, wherein said on-board computer includes said microcontroller and is operably connected to said electronic display.

3. The vehicle advertising system of claim 2 wherein said at least one message is programmable via a mobile device that communicates wirelessly with said on-board computer.

4. The vehicle advertising system of claim 2 wherein said at least one message is downloadable to said on-board computer.

5. The vehicle advertising system of claim 1 wherein said at least one message is selectable from among a plurality of messages for display via said electronic display.

6. The vehicle advertising system of claim 1 wherein said at least one message is provided by an advertiser and comprises an advertisement displayable via said electronic display.

7. The vehicle advertising system of claim 1 further comprising a GPS component wherein a location when said at least one message is displayed by said electronic display is recorded and tracked.

8. The vehicle advertising system of claim 1 wherein a selection of said at least one message is based on parameters preset by a third party advertiser.

9. The vehicle advertising system of claim 1 wherein a selection of said at least one message for display via said electronic display is based on preset variables designated by a driver or an owner of said vehicle.

10. The vehicle advertising system of claim 1 wherein a selection of said at least one message for display via said electronic display is based on preset variables designated by a driver or an owner of said vehicle.

11. The vehicle advertising system of claim 1 wherein a selection of said at least one message for display via said electronic display is based on preset variables including at least one vehicle component associated with said vehicle and/or a location of said at least one vehicle and/or a location of a particular business.

12. The vehicle advertising system of claim 1 further comprising an image-capturing unit for capturing impressions with respect to a display of said at least one message displayed via said electronic display.

13. The vehicle advertising system of claim 1 wherein said electronic display comprises a holographic display.

14. The vehicle advertising system of claim 1 further comprising a beacon that wirelessly communicates with at least one mobile device and/or at least one on-board computer in another vehicle.

15. A vehicle advertising system, comprising:
an electronic display located on a vehicle, said electronic display operably connected to a microcontroller; and
a brake pedal operably connected to said microcontroller and said electronic display, wherein when an operator of said vehicle applies said brake pedal, at least one message is displayed on said electronic display and when said operator releases said brake pedal, said at least one message is no longer displayed via said electronic display; and wherein said at least one message is programmable via an on-board computer integrated with said vehicle, wherein said on-board computer includes said microcontroller and is operably connected to said electronic display and wherein said at least one message is also programmable via a mobile device that communicates wirelessly with said on-board computer.

16. The vehicle advertising system of claim 15 wherein said at least one message is programmable via a mobile device that communicates wirelessly with said on-board computer.

17. The vehicle advertising system of claim 15 wherein said at least one message is downloadable to said on-board computer.

18. A vehicle advertising method, comprising:
locating an electronic display on a vehicle, said electronic display operably connected to a microcontroller; and
providing a brake pedal operably connected to said microcontroller and said electronic display, wherein when an operator of said vehicle applies said brake pedal, at least one message is displayed on said electronic display and when said operator releases said brake pedal, said at least one message is no longer displayed via said electronic display.

19. The vehicle advertising method of claim 18 wherein said at least one message is programmable via an on-board computer integrated with said vehicle, wherein said on-board computer includes said microcontroller and is operably connected to said electronic display.

20. The vehicle advertising method of claim 18 wherein said at least one message is programmable via a mobile device that communicates wirelessly with said on-board computer.
